(19) United States
(12) Patent Application Publication
(10) Pub. No.: US 2019/0272151 A1
(43) Pub. Date: Sep. 5, 2019

(54) METHOD OF GENERATING BINARY POSITIONING TAGS

(71) Applicant: Chunghwa Picture Tubes, LTD., Taoyuan City (TW)

(72) Inventors: Kuo-Hsuan Wu, New Taipei City (TW); Chung-Lin Chia, Taoyuan City (TW)

(73) Assignee: Chunghwa Picture Tubes, LTD., Taoyuan City (TW)

(21) Appl. No.: 16/012,778

(22) Filed: Jun. 20, 2018

(30) Foreign Application Priority Data
Mar. 5, 2018 (CN) 201810177870.4

(51) Int. Cl. G06F 7/58

(52) U.S. Cl. CPC G06F 7/582; G01S 1/68

(57) ABSTRACT

A method of generating binary positioning tags includes the following steps: generating a pseudo random sequence; circularly shifting the pseudo random sequence and sequentially filling in one of a plurality of odd rows and a plurality of even rows of a binary matrix, wherein a size of the binary matrix is M×N; filling a complement sequence of the pseudo random sequence in the other one of the plurality of odd rows and the plurality of even rows; and retrieving a binary submatrix having a size of I×J from the binary matrix according to a relative position of a positioning point to be used as a positioning tag corresponding to the positioning point, wherein I is smaller than M, and J is smaller than N. Accordingly, it is possible to provide a positioning tag that is highly secure, arrangement-unique, and easy to obtain and analyze.

### CROSS-REFERENCE TO RELATED APPLICATION

This application claims the priority benefit of China application serial no. 201810177870.4, filed on Mar. 5, 2018. The entirety of the above-mentioned patent application is hereby incorporated by reference herein and made a part of this specification.

### BACKGROUND OF THE INVENTION

### Field of the Invention

The disclosure relates to a method of generating binary positioning tags.

### Description of Related Art

Nowadays, automation has become the trend for large management systems, and a positioning system assists mobile apparatuses in the large management system to obtain their locations, so that the mobile apparatuses do not lose their orientation. The positioning tag is one of the applications of the positioning system. The positioning tag is generally provided at a corresponding positioning point, and the mobile apparatus obtains location information by analyzing the positioning tag. Therefore, how to design a positioning tag that is easy to analyze has become one of the issues in the field of positioning systems.

### SUMMARY OF THE INVENTION

The embodiments of the invention are directed to a method of generating binary positioning tags to provide positioning tags that are highly secure, arrangement-unique, and easy to obtain and analyze.

The method of generating binary positioning tags according to an embodiment of the invention includes the following steps. A pseudo random sequence is generated. The pseudo random sequence is circularly shifted and is sequentially filled in one of a plurality of odd rows and a plurality of even rows of a binary matrix, wherein a size of the binary matrix is MxN. A complement sequence of the pseudo random sequence is filled in the other one of the plurality of odd rows and the plurality of even rows. A binary submatrix having a size of I×J is retrieved from the binary matrix according to a relative position of a positioning point to be used as a positioning tag corresponding to the positioning point, wherein I is smaller than M, and J is smaller than N.

### BRIEF DESCRIPTION OF THE DRAWINGS

The accompanying drawings are included to allow further understanding of the embodiments of invention, and the drawings are incorporated into the specification and form a part of the specification. The drawings illustrate the embodiments of the invention and the drawings and the description together are used to interpret the principles of the invention.

FIG. 1 is a flowchart illustrating a method of generating binary positioning tags according to an embodiment of the invention.

FIG. 2 is a schematic diagram illustrating a configuration of a plurality of odd rows of a binary matrix according to an embodiment of the invention.

FIG. 3 is a schematic diagram illustrating a configuration of a plurality of even rows of a binary matrix according to an embodiment of the invention.

FIG. 4 is a schematic diagram illustrating a completed binary matrix according to an embodiment of the invention.

FIG. 5 is a schematic diagram illustrating acquisition of binary submatrices according to an embodiment of the invention.

FIG. 6 is a schematic diagram illustrating calculation of a third order primitive polynomial according to an embodiment of the invention.

FIG. 7 is a schematic diagram illustrating calculation of a fourth order primitive polynomial according to an embodiment of the invention.

### DESCRIPTION OF THE EMBODIMENTS

Reference will now be made in detail to the exemplary embodiments of the invention, examples of which are illustrated in the accompanying drawings. Wherever possible, the same reference numbers are used in the drawings and the description to refer to the same or like parts.

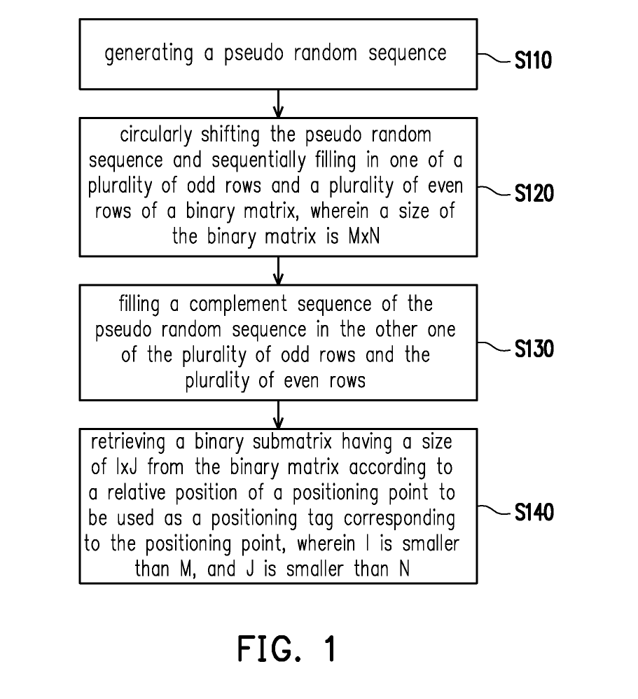

FIG. 1 is a flowchart illustrating a method of generating binary positioning tags according to an embodiment of the invention. Referring to FIG. 1, in the present embodiment, the method of generating binary positioning tags includes the following steps. In step S110, a pseudo random sequence is generated. Specifically, the pseudo random sequence may be generated by any circuit or algorithm (for example, being generated by using a primitive polynomial), but the embodiments of the invention are not limited hereto. Moreover, before the pseudo random sequence is generated, a quantity of positioning tags is confirmed (namely, a single-dimension length of the positioning tags is determined).

Next, in step S120, the pseudo random sequence is circularly shifted and then is sequentially filled in one of a plurality of odd rows and a plurality of even rows of a binary matrix, wherein a size of the binary matrix is M×N, N is a positive integer larger than 1 and corresponds to the single-dimension length of the positioning tags, and M is 2 times N. In step S130, a complement sequence of the pseudo random sequence is filled in the other one of the plurality of odd rows and the plurality of even rows, wherein the complement sequence is l's complement of the pseudo random sequence.

Lastly, in step S140, a binary submatrix having a size of I×J is retrieved from the binary matrix according to a relative position of a positioning point to be used as a positioning tag corresponding to the positioning point, wherein I is a positive integer smaller than M, and J is a positive integer smaller than N.

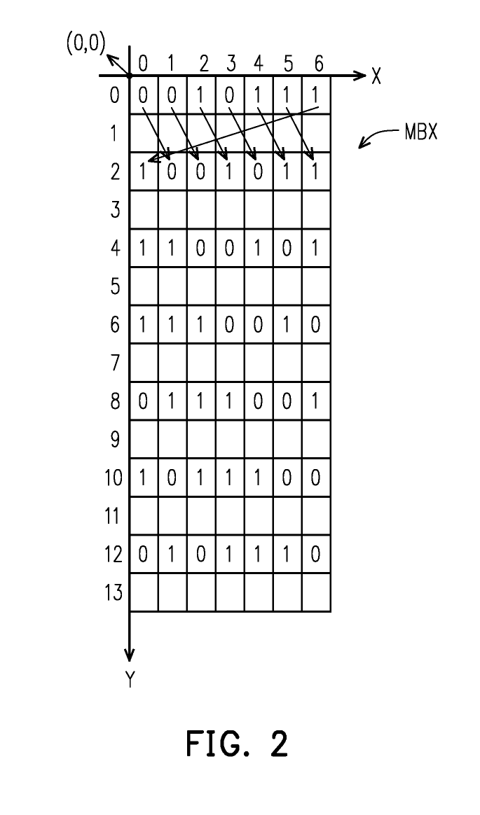

FIG. 2 is a schematic diagram illustrating a configuration of a plurality of odd rows of a binary matrix according to an embodiment of the invention. Referring to FIG. 1 and FIG. 2, in the present embodiment, supposing that N=7, a positioning resolution of the positioning tag is 7×14, and the pseudo random sequence obtained in step S120 is a sequence of 7 bits, e.g., “0010111”. At this time, the pseudo random sequence “0010111” is filled in the 0^{th} row (the corresponding odd row) of the binary matrix MBX, and the pseudo random sequence “0010111” is circularly shifted right by 1 bit and becomes “1001011”. The pseudo random sequence “1001011” after the right circular shift is then filled in the 2^{nd} row (the corresponding odd row) of the binary matrix MBX. Analogously, the pseudo random sequence “0010111” is sequentially circularly shifted right by 1 bit and is sequentially filled in the 2^{nd}, 4^{th}, 6^{th}, 8^{th}, 10^{th}, 12^{th} rows of the binary matrix MBX.

In the foregoing embodiment, the pseudo random sequence “0010111” is sequentially circularly shifted right. However, in other embodiments, the pseudo random sequence “0010111” may be sequentially circularly shifted left, and the embodiments of the invention are not limited hereto.

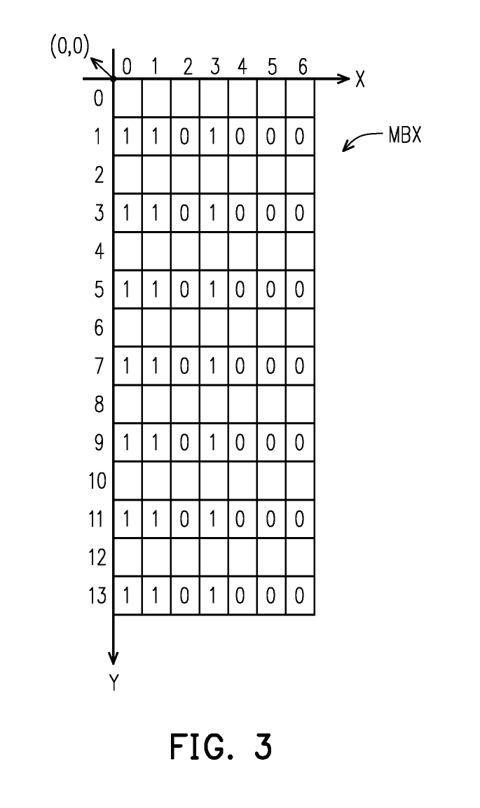

FIG. 3 is a schematic diagram illustrating a configuration of a plurality of even rows of a binary matrix according to an embodiment of the invention. Referring to FIG. 1 and FIG. 3, in the present embodiment, supposing that N=7, the pseudo random sequence obtained in step S120 is a sequence “0010111” of 7 bits, and a complement sequence “1101000” of 1's complement of the pseudo random sequence “0010111” is obtained. Next, the complement sequence “1101000” is simultaneously filled in the 1^{st}, 3^{rd}, 5^{th}, 7^{th}, 9^{th}, 10^{th}, 13^{th} rows (the corresponding even rows) of the binary matrix MBX.

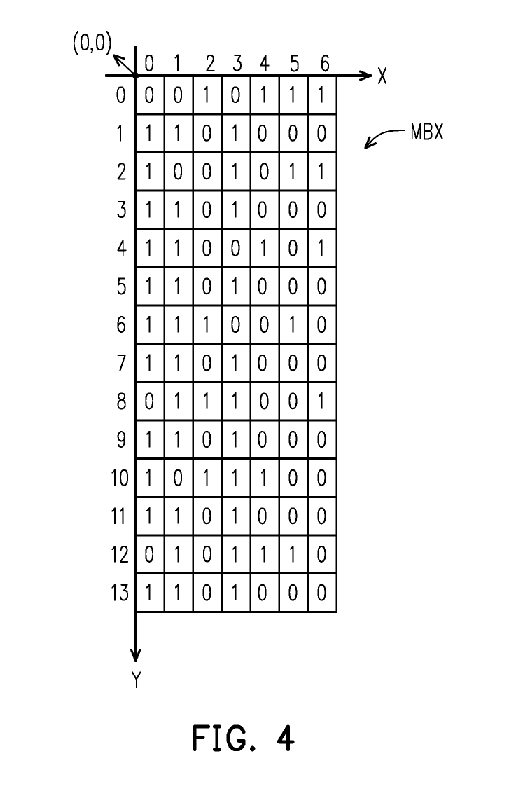

FIG. 4 is a schematic diagram illustrating a completed binary matrix according to an embodiment of the invention. Referring to FIG. 2 to FIG. 4, after the binary matrices MBX shown in FIG. 2 and FIG. 3 are combined, the binary matrix MBX shown in FIG. 4 is obtained. In the present embodiment, supposing that the upper-left corner of the binary matrix MBX corresponds to coordinates (0, 0).

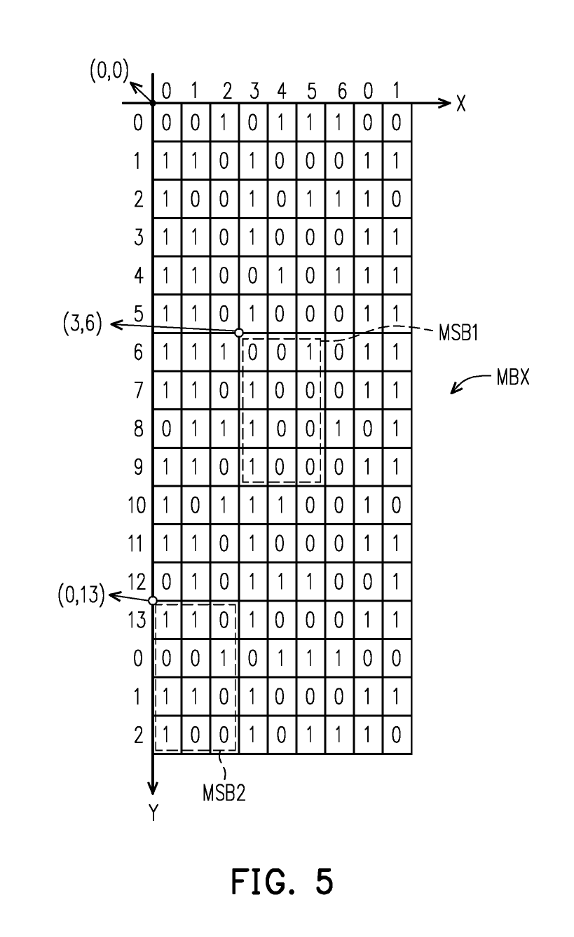

FIG. 5 is a schematic diagram illustrating acquisition of binary submatrices according to an embodiment of the invention. Referring to FIG. 1, FIG. 4, and FIG. 5, in the present embodiment, supposing that I=3, J=4, and the upper-left corner of the positioning tag (i.e., the binary submatrix) is aligned with a relative position of a positioning point. If the relative position of the positioning point is (3, 6), a binary submatrix MSB1 is obtained; if the relative position of the positioning point is (0, 13), a binary submatrix MSB2 is obtained. Moreover, to prevent obtaining a null value for the binary submatrices (e.g., MSB1 and MSB2), in the established binary matrix MBX, the 0^{th} and 1^{st} columns of the X-axis are filled in (namely, I-1 columns are filled in) after the 6^{th} column of the X-axis, and the 0^{th} to 2^{nd} rows of the Y-axis are filled in (namely, J-1 rows are filled in) after the 13^{th} row of the Y-axis.

Since the complement sequence “1101000” is simultaneously filled in the 1^{st}, 3^{rd}, 5^{th}, 7^{th}, 9^{th}, 11^{th}, 13^{th} rows (the corresponding even rows) of the binary matrix MBX, the complement sequence “1101000” may be used to define an X position of the positioning point. Since the pseudo random sequences filled in the 2^{nd}, 4^{th}, 6^{th}, 8^{th}, 10^{th}, 12^{th} rows of the binary matrix MBX are sequentially circularly shifted right along the Y-axis, the circularly shifted pseudo random sequences may be used to define a Y position of the positioning point.

In the present embodiment, since the binary matrix MBX is established by using the pseudo random sequences, the positioning tags (e.g., the binary submatrix MSB1 or MSB2) is highly secure, arrangement-unique, and easy to obtain and analyze.

When the positioning tag shown as the binary submatrix MSB1 is obtained, it is rapidly known that two rows having the same content are the even rows (100) of the binary submatrix MSB1. After the two even rows (100) having the same content are compared with the complement sequence “1101000”, it is known that the X-axis position of the binary submatrix MSB1 is 3. Then, after the first row (001) of the binary submatrix MSB1 is compared with the pseudo random sequence “0010111”, it is known that the sequence “001” corresponds to the X-axis position 0. Therefore, through the foregoing comparison, it is found that the positioning tag (i.e., the binary submatrix MSB1) is moved from the X-axis position 0 to the X-axis position 3 (namely, being circularly shifted right three times). Then, by using the formula ((3-0)×2=6), it is calculated that the Y-axis position is 6. Therefore, the positioning tag (i.e., the binary submatrix MSB1) corresponds to the position (3, 6).

When the positioning tag shown as the binary submatrix MSB2 is obtained, it is rapidly known that two rows having the same content are the odd rows (110) of the binary submatrix MSB2. After the two odd rows (110) having the same content are compared with the complement sequence “1101000”, it is known that the X-axis position of the binary submatrix MSB2 is 0. Then, after the second row (001) of the binary submatrix MSB2 is compared with the pseudo random sequence “0010111”, it is known that the sequence “001” corresponds to the X-axis position 0. Therefore, it is found that the positioning tag (i.e., the binary submatrix MSB2) is moved from the X-axis position 0 to the X-axis position 0 (namely, being circularly shifted right seven times). Then, by using the formula ((7+0−0)×2−1=13), it is calculated that the Y-axis position is 13. Therefore, the positioning tag (i.e., the binary submatrix MSB2) corresponds to the position (0, 13).

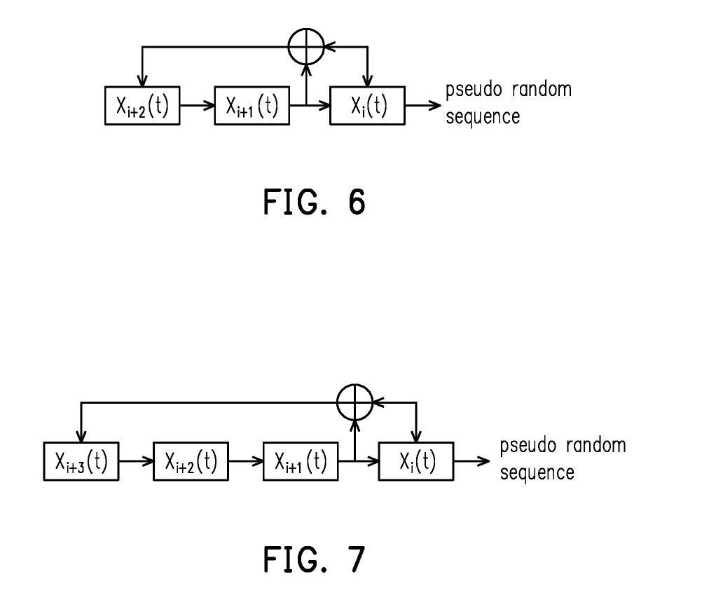

FIG. 6 is a schematic diagram illustrating calculation of a third order primitive polynomial according to an embodiment of the invention. Referring to FIG. 1 and FIG. 6, in the present embodiment, an order of the primitive polynomial is determined by N. Namely, N=2^{m}−1, wherein m is the order of the primitive polynomial. If the order m of the primitive polynomial is 3, relevant functions are Xᵢ(t), Xᵢ₊₁(t), and Xᵢ₊₂(t). Moreover, an initial value of Xᵢ(t) is 0, an initial value of Xᵢ₊₁(t) is 0, an initial value of Xᵢ₊₂(t) is 1, and a first value of the pseudo random sequence is 0. At this time, a time t is 0 seconds.

Next, Xᵢ(t+1) is Xᵢ₊₁(t), Xᵢ₊₁(t+1) is Xᵢ₊₂(t), and Xᵢ₊₂(t+1) is Xᵢ(t) XOR wherein XOR means that the identical number (0 and 0 or 1 and 1) between Xᵢ(t) and Xᵢ₊₁(t) is 0, and the different number (0 and 1 or 1 and 0) is 1. Inferring analogously, it is derived that the pseudo random sequence is “0010111”.

FIG. 7 is a schematic diagram illustrating calculation of a fourth order primitive polynomial according to an embodiment of the invention. Referring to FIG. 6 and FIG. 7, in the present embodiment, the operation of the fourth order primitive polynomial is largely identical to the operation of the third order primitive polynomial. The difference lies in that the fourth order primitive polynomial additionally includes a function Xᵢ₊₃(t).

Accordingly, in the method of generating binary positioning tags of the embodiments of the invention, the pseudo random sequence is established by using the primitive polynomial. Therefore, without understanding the establishment basis, the content of the binary positioning tags cannot be analyzed. In other words, the positioning tags are highly secure. Moreover, the pseudo random sequence is not only unique, but it is also possible to provide different quantities of the positioning tags according to the primitive polynomials of different orders. In other words, the positioning tags are unique and are sufficient in quantity. Since the positioning tags have binary properties (namely, consisting of 0 (black) and 1 (white)), with understanding of the establishment basis, the positioning tags are easy to obtain and analyze.

Lastly, it shall be noted that the foregoing embodiments are meant to illustrate, rather than limit, the technical solutions of the embodiments of the invention. Although the invention has been detailed with reference to the foregoing embodiments, persons ordinarily skilled in the art shall be aware that they may still make modifications to the technical solutions recited in the foregoing embodiments or make equivalent replacements of part or all of the technical features therein, and these modifications or replacements do not cause the nature of the corresponding technical solutions to depart from the scope of the technical solutions of the embodiments of the invention.

What is claimed is:

1. A method of generating binary positioning tags, comprising:
generating a pseudo random sequence;
circularly shifting the pseudo random sequence, and sequentially filling in one of a plurality of odd rows and a plurality of even rows of a binary matrix, wherein a size of the binary matrix is M×N;
filling a complement sequence of the pseudo random sequence in the other one of the plurality of odd rows and the plurality of even rows; and
retrieving a binary submatrix having a size of I×J from the binary matrix according to a relative position of a positioning point to be used as a positioning tag corresponding to the positioning point, wherein I is smaller than M, and J is smaller than N.

2. The method of generating binary positioning tags according to claim 1, wherein the pseudo random sequence is circularly shifted right.

3. The method of generating binary positioning tags according to claim 1, wherein the pseudo random sequence is circularly shifted left.

4. The method of generating binary positioning tags according to claim 1, wherein N corresponds to a quantity of the positioning tags of a single dimension.

5. The method of generating binary positioning tags according to claim 1, wherein the pseudo random sequence is generated by using a primitive polynomial.

6. The method of generating binary positioning tags according to claim 5, wherein an order of the primitive polynomial is determined by N.

7. The method of generating binary positioning tags according to claim 6, wherein N=2^{m}−1, wherein m is the order of the primitive polynomial.

8. The method of generating binary positioning tags according to claim 1, wherein an upper-left corner of the positioning tag is aligned with the positioning point.

9. The method of generating binary positioning tags according to claim 1, wherein the complement sequence of the pseudo random sequence is used to define an X position of the positioning point, and the circularly shifted pseudo random sequence is used to define a Y position of the positioning point.

10. The method of generating binary positioning tags according to claim 1, wherein the complement sequence is 1's complement of the pseudo random sequence.

11. The method of generating binary positioning tags according to claim 1, wherein the pseudo random sequence is circularly shifted by one bit.
